(19) United States
(12) Patent Application Publication
(10) Pub. No.: US 2024/0199208 A1
(43) Pub. Date: Jun. 20, 2024

(54) AIRCRAFT WITH CARGO COMPARTMENT

(71) Applicant: Airbus Operations GmbH, HAMBURG (DE)

(72) Inventors: Konstantin KALLERGIS, HAMBURG (DE); Kai CHRISTENSEN, HAMBURG (DE)

(21) Appl. No.: 18/535,331

(22) Filed: Dec. 11, 2023

(30) Foreign Application Priority Data
Dec. 14, 2022 (EP) 22213617.8

(51) Int. Cl. B64D 9/00; B64D 45/00

(52) U.S. Cl. CPC B64D 9/00; B64D 45/00; B64D 2045/009

(57) ABSTRACT

An aircraft having a cargo compartment, with the cargo compartment including a lining with respective burn-through protection, and a modular fire barrier made of a multiplicity of fire barrier elements. The fire barrier elements include a material offering additional burn-through protection in relation to the material of the lining of the cargo compartment.

### CROSS-REFERENCES TO RELATED APPLICATIONS

This application claims the benefit of the European patent application No. 22213617.8 filed on Dec. 14, 2022, the entire disclosures of which are incorporated herein by way of reference.

### FIELD OF THE INVENTION

The present application relates to an aircraft with a cargo compartment, and the cargo compartment comprises a lining with burn-through protection.

### BACKGROUND OF THE INVENTION

Such cargo compartments are known and are subject to regulatory safety guidelines. In particular, the Federal Aviation Regulation (FAR) determines rules for the length of time that should pass without flame penetration at a certain temperature; cf. FAR 25.857: In the event of use of a 2 gallon-per-hour kerosene burner, the samples must be exposed to flame for 5 minutes. The samples must also withstand burn-through and the maximum temperature (measured at a distance of 4 inches (˜10.16 cm) above the horizontally arranged sample) should not exceed 400° Fahrenheit)(˜200° C.).

When batteries are being transported, however, thermal runaway can cause a self-amplifying heat-producing process, which generates temperatures above 660° C., to occur.

AmSafe Bridport offers coverings for containing fires, in particular lithium ion battery fires. From experience, however, these containment covers are awkward to handle since they must be arranged around the cargo container before the latter is loaded.

It is therefore desirable and an object of the present application to provide an aircraft having a cargo compartment which offers increased protection for battery transport and at the same time enables straightforward handling.

### SUMMARY OF THE INVENTION

A fundamental aim of the present application is to provide an additional fire barrier for a cargo compartment, so that a fire can be contained in the cargo compartment for longer without burning through, and therefore the pilot has more time to make an emergency landing.

The aircraft according to the invention has a cargo compartment, the cargo compartment comprising a lining with respective burn-through protection, and the cargo compartment also comprising a modular fire barrier made of a multiplicity of fire barrier elements, which comprise a material offering additional burn-through protection in relation to the material of the lining of the cargo compartment.

The modular fire barrier according to the invention is movable between a storage state and a use state. In this way, the cargo can be brought to the desired position in the cargo compartment as is customary, using roller conveyor(s) and power drive units (PDUs) or by hand, without the modular fire barrier being in the way, and then subsequently enclosed by the modular fire barrier when it is brought into the use state.

In one embodiment according to the invention, the storage state of the modular fire barrier or the fire barrier elements comprises integral storage in the cargo compartment. It may, for example, be designed like a roller blind or a roll-up/roll-down blind, with the result that the modular fire barrier can be easily brought from the storage state into the use state (for example by pulling it out, up or down and—if desired—subsequently securing it to the ceiling, floor or side wall). It is possible, for example, for the fire barrier elements to be stored simply rolled up on the ceiling of the cargo compartment and lowered like a curtain. In the present case, integral means that the modular fire barrier is located in the cargo compartment permanently and does not hinder loading and unloading in the storage state.

The fire barrier elements are preferably securable to the lining of the cargo compartment by means of quick-action securing means, in such a way that one or more regions of the cargo compartment have the additional burn-through protection. In this way, various cargo set-down locations of different sizes can be equipped with the improved burn-through protection. The quick-action closures make it possible to quickly and easily install the fire barrier elements. Suitable quick-action securing means are, for example, hook-and-loop closures and/or zip fasteners, but other mechanical simple securing options, such as hooks/eyes or the like, are self-evidently also possible.

The lining comprises lateral elements and/or ceiling elements and/or floor elements of the cargo compartment. This makes it possible to erect the modular fire barrier flexibly in all regions of the cargo compartment.

The cargo compartment is preferably suitable for securing unit load devices (ULDs, such as pallets or containers) at least at one specific position and the one or more regions with the additional burn-through protection include one or more desired volumes around the at least one specific position for securing ULDs. This makes it possible to selectively create fire protection for special ULDs with batteries at multiple positions in the cargo compartment.

In a special configuration of the present application, for example, a fire barrier element may also be arranged in the form of individual strips of material on one of the floor panels of the cargo compartment (between the seat rails serving to secure cargo, with the result that they continue to be available normally for tying down cargo by means of latches or tie down straps). After the aircraft cargo compartment is loaded, for example with a container, the latter is in its tied-down position of travel, that is to say, directly above the strips of material of the fire barrier element. It is then connected to the fire barrier elements, which are, for example, suspended from the ceiling, by quick-action securing means, resulting in the formation of a closed volume with increased burn-through protection.

In the aircraft according to the invention, it is possible that the cargo compartment is arranged in the lower deck and/or on the main deck of the aircraft. The aircraft may be a passenger aircraft or a purely freight aircraft (also having multiple freight decks).

The fire barrier elements according to the invention preferably contain aramids, since the latter comprise high-strength fibers that are resistant to high temperatures and offer proven protection against fire.

According to the invention, the modular fire barrier made of a multiplicity of fire barrier elements may also comprise at least one temperature sensor and/or one smoke sensor. Of course, other sensor types are also additionally or alternatively conceivable, provided that their sensor systems can give an indication of thermal runaway. For example hydrogen (H₂), carbon monoxide (CO), carbon dioxide (CO₂), ethylene (C₂H₄) or methane (CH₄) come into consideration for this. This at least one sensor is communicatively coupled to an aircraft management system, with the result that it advises the pilot about the status of the transported cargo in the at least one specially partitioned region. This allows the pilot to react particularly quickly to a fire in the cargo area.

### BRIEF DESCRIPTION OF THE DRAWINGS

The invention will be explained below with reference to the drawings.

FIG. 1 shows, by way of example, an outer view of an aircraft according to the invention.

FIG. 2 shows a cargo compartment of an aircraft with a modular fire barrier.

FIG. 3 shows a cargo compartment of an aircraft with a modular fire barrier around a container.

### DETAILED DESCRIPTION OF THE PREFERRED EMBODIMENTS

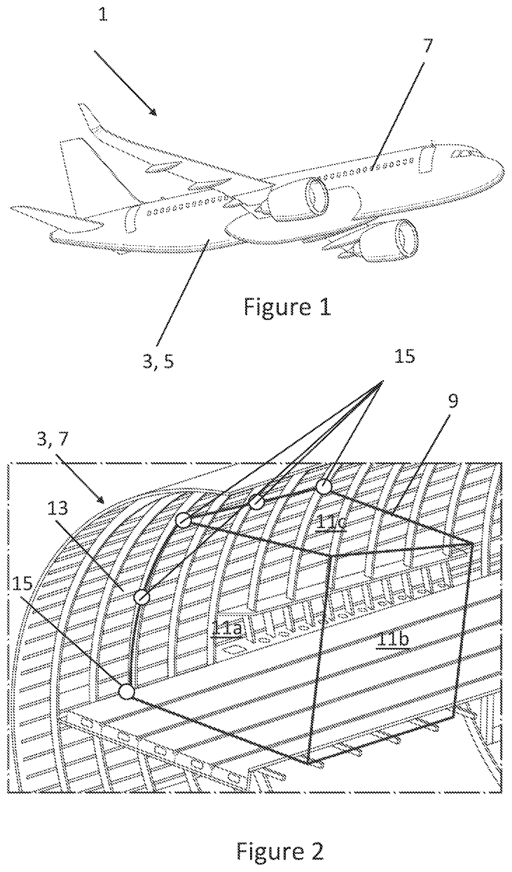

FIG. 1 is the outer view of an aircraft 1 according to the invention. The cargo compartment 3 may be arranged both in the lower deck 5 and/or on the main deck 7 of the aircraft 1. The image shows a passenger aircraft (A320) having a passenger region, including windows, on the main deck 7, and therefore the cargo compartment 3 is arranged in the lower deck 5.

The cargo compartment 3 illustrated in FIG. 2 is located on the main deck 7 of the aircraft 1. The image shows a cargo compartment 3 of an aircraft 1 according to the invention having a schematically illustrated modular fire barrier 9 made of a multiplicity of fire barrier elements 11a, 11b, 11c, only two lateral elements and the upper covering being illustrated here. As a result, the space enclosed by the fire barrier elements 11a, 11b, 11c, . . . , 11i has additional burn-through protection in relation to the rest of the cargo compartment 3. The fire barrier elements 11a, 11b, 11c, . . . , 11i preferably comprise aramids, since they offer proven protection against fire.

The fire barrier elements 11a, 11b, 11c, . . . , 11i may be secured to the lining 13 of the cargo compartment 3 by means of quick-action securing means, such as hook-and-loop closures and/or zip fasteners. As can be seen in FIG. 2, “be secured” for a fire barrier element can mean that only one or more lateral edges of a fire barrier element are secured to the lining. This can be effected, for example, by punctiform securing points 15, but of course they may also have a different form, such as strips. Other fire barrier elements of the same modular fire barrier can then be secured to the ceiling (this scenario is not illustrated), with the result that individually required protection volumes can be created.

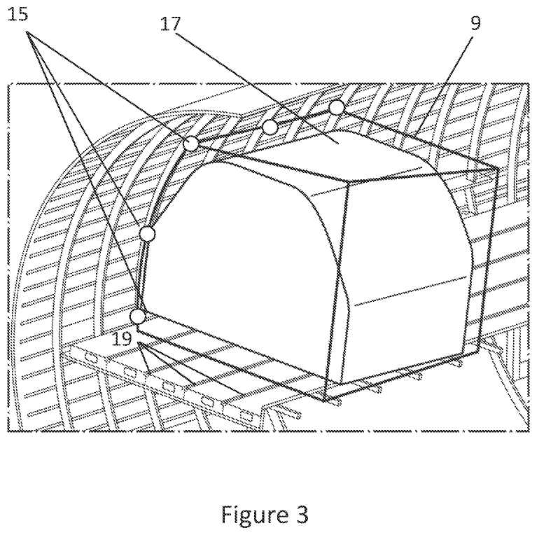

FIG. 3 shows the modular fire barrier 9 from FIG. 2, which at least partially surrounds a container 17. This is intended to show, by way of example, that the aircraft 1 according to the invention with the cargo compartment 3 is suitable for securing unit load devices (ULDs) (such as the container 17 illustrated) at least at one specific position. In this respect, this region may comprise a desired volume around the at least one specific position for securing ULDs. To secure the container 17, it is then possible to use tie-down straps or latches which are conventional for cargo compartments and are arranged in the seat rail profiles 19 illustrated.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An aircraft having a cargo compartment, the cargo compartment comprising:
a lining comprising a material with respective burn-through protection, and
a modular fire barrier made of a multiplicity of fire barrier elements, which comprise a material offering additional burn-through protection in relation to the material of the lining of the cargo compartment.

2. The aircraft as claimed in claim 1, the modular fire barrier being movable between a storage state and a use state.

3. The aircraft as claimed in claim 2, the storage state comprising integral storage in the cargo compartment.

4. The aircraft as claimed in claim 1, the fire barrier elements being securable to the lining of the cargo compartment by means of quick-action securing means, such that one or more regions of the cargo compartment have the additional burn-through protection.

5. The aircraft as claimed in claim 1, the lining comprising at least one of lateral elements, ceiling elements, or floor elements of the cargo compartment.

6. The aircraft as claimed in claim 4, the cargo compartment being suitable for securing unit load devices (ULDs) at least at one specific position and the one or more regions including one or more desired volumes around the at least one specific position for securing ULDs.

7. The aircraft as claimed in claim 1, the cargo compartment being arranged in at least one of a lower deck or on a main deck of the aircraft.

8. The aircraft as claimed in claim 4, the quick-action securing means comprising at least one of hook-and-loop closures or zip fasteners.

9. The aircraft as claimed in claim 1, the fire barrier elements comprising aramids.

10. The aircraft as claimed in claim 1, the fire barrier elements also comprising at least one sensor for detecting at least one of temperature, smoke, hydrogen, carbon monoxide, carbon dioxide, ethylene or methane.

11. The aircraft as claimed in claim 10, the at least one sensor being communicatively coupled to an aircraft management system.
